(19) United States
(12) Patent Application Publication
(10) Pub. No.: US 2012/0300644 A1
(43) Pub. Date: Nov. 29, 2012

(54) METHOD AND DEVICE FOR ESTIMATING CARRIER FREQUENCY OFFSET

(76) Inventors: Ho Wang Patrick Fung, Singapore (SG); Sumei Sun, Singapore (SG); Chin Keong Ho, Singapore (SG)

(21) Appl. No.: 13/575,594

(22) PCT Filed: Jan. 26, 2011
(86) PCT No.: PCT/SG2011/000036

§ 371 Date: Jul. 26, 2012

(30) Foreign Application Priority Data
Jan. 26, 2010 (SG) 201000591-6

(51) Int. Cl. H04B 7/14; H04L 12/26

(52) U.S. Cl. 370/246

(57) ABSTRACT

A method (500) for estimating a carrier frequency offset in a communication system (100) is disclosed herein. In a described embodiment, the communications system (100) comprises a first communications device (120), a second communications device (122) and a relay (110). The method (500) comprises rotating (530) at the first communications device (120) a first generated block of signals by a first plurality of different rotation angles to form a corresponding first set of preambles (410), rotating (530) at the second communications device (122) a second generated block of signals by a second plurality of different rotation angles to form corresponding second set of preambles (420), transmitting (540) from each of the first and second communications devices (120,122) the respective first and second sets of preambles (410, 420) as time domain signals to the relay (110), receiving at the first communications device (120) a retransmitted time domain signal from the relay (110), the retransmitted signal being a combination of the first and second sets of preambles (410, 420) and estimating (550) the channel frequency offset based on the received retransmitted time domain signal. A device and an integrated circuit for estimating a carrier frequency offset in a communication system are also disclosed.

### FIELD OF THE INVENTION

The present invention relates to a method and device for estimating carrier frequency offset, particularly but not exclusively for two-way relays.

### BACKGROUND OF THE INVENTION

The technique of relaying for introducing cooperative diversity to wireless transmission has potential for throughput and range extension. In particular, two-way relays are an efficient network transmission scheme that is capable of supporting the exchange of data packets between two source nodes in only half the time required in one-way relays. In two-way relays, two source nodes send independent data streams using the same time slots and bandwidth. However, since the spectral resources are shared, the signal communicated by any one source node is delivered not only across to the other source node, but also back to itself as an interference by way of the relay node. Thus, consideration is given to interferences when designing preambles for frequency synchronization in two-way relay systems.

One widely applied preamble for frequency synchronization in point-to-point transmissions has the periodic structure adopted in the IEEE 802.11a/g/n standard. This preamble however when applied to two-way relay setups results in transmissions from the source nodes that may not be differentiated once the transmissions blend into each other before arriving at the relay node. When this happens, when the relay node redirect this received composite signal back to the two source nodes, the carrier frequency offset (CFO) between the two source nodes may no longer be estimated reliably. Thus, standard preambles presently used for point-to-point transmissions or one-way relay transmissions may not be readily applied to two-way relay transmissions.

Training sequences designed for relay networks are known and may be used for CFO estimation but these training sequences are generally catered for the purpose of channel estimation. For example, the periodic Constant Amplitude Zero AutoCorrelation (CAZAC) sequence based preamble for one-way relaying may be used for estimation of the CFO between a destination and multiple relay stations. In this case however, an error floor in the CFO estimates is observed at high SNR due to the presence of inter-carrier-interference caused by the CFO. Also, this strategy is designed for one-way relays and performance degrades when applied to two-way relaying.

It is an object of the present invention to provide an method and device for estimating CFO which addresses at least one of the problems of the prior art and/or to provide the public with a useful choice.

### SUMMARY OF THE INVENTION

In a specific expression of the invention, there is provided a method for estimating carrier frequency offset at a communications device, the method comprising:
generating a block of signals;
rotating the block by a plurality of different rotation angles to form a corresponding first set of preambles;
transmitting the first set of preambles as a time domain signal to a relay;
receiving a retransmitted time domain signal from the relay, the retransmitted time domain signal being a combination of the first set of preambles and a second set of preambles from another communication device; and
estimating the channel frequency offset based on the received retransmitted time domain signal.

The method may further comprise applying an optimized modulation to the first set of preambles to form the time domain signal. Preferably, each signal of the block of signals correspond to respective ones of a plurality of subcarriers used for transmitting the first set of preambles.

Advantageously, the method may further comprise:
permuting a plurality of combinations each associating an arrangement of the rotated block of signals with a plurality of constellations;
modulating each of the plurality of combinations with respective ones of the plurality of subcarriers; and
selecting from the modulated plurality of combinations a selected signal of an optimal combination, the optimal combination minimizing the peak-to-average power ratio of the corresponding signal; wherein the selected signal is the time domain signal.

Preferably, the method may further comprise determining a plurality of modulation symbols used by the plurality of subcarriers to form each of the first set of preambles. The method may further comprise shifting a frequency of each of the signals by applying one of the plurality of different rotation angles. Optionally, rotating at the communications device the generated block of may comprise scaling an amplitude of each of the signals.

In a variation, one of the plurality of different rotation angles may be obtained from the number of the plurality of subcarriers and a predetermined length of the time domain signal. Optionally, one of the plurality of different rotation angles may be obtained from an angle of a previous block of signals.

Advantageously, one of the plurality of different rotation angles may be determined using a Cramer Rao bound of the carrier frequency offset estimate. Optionally, the Cramer Rao bound may be an approximation. Preferably, one of the plurality of different rotation angles may have a value between and inclusive of 0 and π.

In a second variation, one of the plurality of different rotation angles may be obtained according to the number of other communication devices.

Optionally, the generated block may be an IEEE 802.11 preamble. Preferably, one of the first set of preambles may be obtained from rotating a preceding rotated block of signals. Optionally, the time domain signal may be transmitted using orthogonal frequency-division multiplexing.

Preferably, the time domain signal is non-periodic. Preferably, the retransmitted time domain signal may comprise a training signal retransmitted by the relay from another device. Preferably, the carrier frequency offset is between the time domain signal and the received retransmitted time domain signal.

Advantageously, estimating the carrier frequency offset may comprise linear filtering the received retransmitted time domain signal. In a further variation, estimating the carrier frequency offset may further comprise performing correlation on the linear filtered signal.

In a second specific expression of the invention, there is provided a relaying method for estimating carrier frequency offset at a first communications device, the method comprising:
receiving at a relay a first time domain signal which is transmitted from the first communications device, and a second time domain signals which is transmitted from a second communications device;
wherein the first time domain signal comprises a first set of preambles formed by rotating a first generated block of signals by a corresponding first plurality of different rotation angles; and
wherein the second time domain signal comprises a second set of preambles formed by rotating a second generated block of signals by a corresponding second plurality of different rotation angles; and
retransmitting from the relay a retransmitted time domain signal to the first communications device so as to allow the first communications device to estimate the carrier frequency offset based on the retransmitted time domain signal, which is a combination of the first and second sets of preambles.

In a third specific expression of the invention, there is provided a method for estimating a carrier frequency offset in a communication system, the communications system comprising a first communications device, a second communications device and a relay, the method comprising:
rotating at the first communications device a first generated block of signals by a first plurality of different rotation angles to form corresponding first set of preambles;
rotating at the second communications device a second generated block of signals by a second plurality of different rotation angles to form corresponding second set of preambles;
transmitting from each of the first and second communications devices the respective first and second sets of preambles as time domain signals to the relay;
receiving at the first communications device a retransmitted time domain signal from the relay, the retransmitted signal being a combination of the first and second sets of preambles; and,
estimating the channel frequency offset based on the received retransmitted time domain signal.

In the third specific expression, advantageously, a starting angle of the first plurality of different rotation angles and a starting angle of the second plurality of different rotation angles may differ by π. Preferably, the starting angle of the first plurality of different rotation angles is 0.

The present invention also relates to an apparatus or communications device for performing any of the above discussed methods or those which are described in the preferred embodiments. Specifically, in a fourth specific expression of the invention, there is provided a communications device comprising:
a processor configured to generate a block of signals and to rotate the block by a plurality of different rotation angles to form corresponding first set of preambles; and
a transmitter configured to transmit the first set of preambles as a time domain signal to a relay,
a receiver configured to receive a retransmitted time domain signal from the relay, the retransmitted time domain signal being a combination of the first set of preambles and a second set of preambles from another communication device; and
wherein the processor is further configured to estimate the channel frequency offset based on the received retransmitted time domain signal.

In a fifth specific expression of the invention, there is provided an integrated circuit for a communications device, comprising:
a processing unit configured to generate a block of signals and to rotate the block by a plurality of different rotation angles to form a corresponding first set of preambles;
an interface configured to transmit the first set of preambles as a time domain signal to a relay and further configured to receive a retransmitted time domain signal from the relay, the retransmitted time domain signal being a combination of the first set of preambles and a second set of preambles from another communication device; and
wherein the processing unit is further configured to estimate the channel frequency offset based on the received retransmitted time domain signal.

It can be appreciated from the described embodiment(s) that the method and devices may:
generate and transmit preambles with a low peak-to-average power ratio (PAPR);
lower the complexity of estimating CFO;
be robust towards the use of different frequency estimation techniques when estimating the CFO;
produce accurate CFO estimation;
have a CFO estimation performance which is near optimal;
use for removing known frequency components a filter which allows CFO estimation performance to be near a Cramer Rao bound;
use estimator circuits which are of low complexity without suffering performance loss or loss in estimation accuracy;
not have any constraints on the number of relay stations or the number of antennas in each station;
use inexpensive circuits which are distortion-free for CFO estimation; and
have a preamble structure with sufficient degrees of freedom for PAPR optimization.

### BRIEF DESCRIPTION OF THE FIGURES

A preferred embodiment of the invention will now be described, by way of example only, with reference to the accompanying drawings, in which:

FIG. 1 is a schematic drawing of a communications system having two source nodes and a relay node, according to a preferred embodiment;

FIG. 2 is a schematic drawing of a transmitting portion of the source nodes of FIG. 1;

FIG. 3 is a schematic drawing of a receiving portion of the source nodes of FIG. 1;

FIG. 4 is a schematic drawing of two sets of rotated preambles that are generated and transmitted from the transmitting portion of FIG. 2;

FIG. 5 is a flow diagram of a method of estimating a CFO in the communications system of FIG. 1;

FIG. 6 is a flow diagram of a method of generating and transmitting preambles at the transmitting portion of FIG. 2;

FIG. 7 is a graph of the value of a minimum CFO estimation error for different numbers of CFO estimation blocks as the CFO is varied;

FIG. 8 is a graph of a time domain waveform of one of the preambles of FIG. 5;

FIG. 9 is a graph of a frequency domain waveform of one of the preambles of FIG. 5;

FIG. 10 is a graph of the mean squared error (MSE) in the CFO estimation of FIG. 5 as a SNR is varied and where channel conditions of a Scenario 1 are applied;

FIG. 11 is a graph of the MSE in the CFO estimation of FIG. 5 as a SNR is varied and where channel conditions of a Scenario 2 are applied; and

FIG. 12 is a graph of the MSE in the CFO estimation of FIG. 5 as a SNR is varied and where channel conditions of a Scenario 3 are applied.

### DETAILED DESCRIPTION OF THE PREFERRED EMBODIMENT

The following notations may be used in this specification. Boldfaces in capital and small letters respectively denote matrices and vectors. All indices in matrices and vectors start from zero unless otherwise stated. The symbol \textcircled{×} denotes a convolution. N(O,R) denotes a multivariate Gaussian distribution with a zero mean and with a covariance matrix R.

System Model

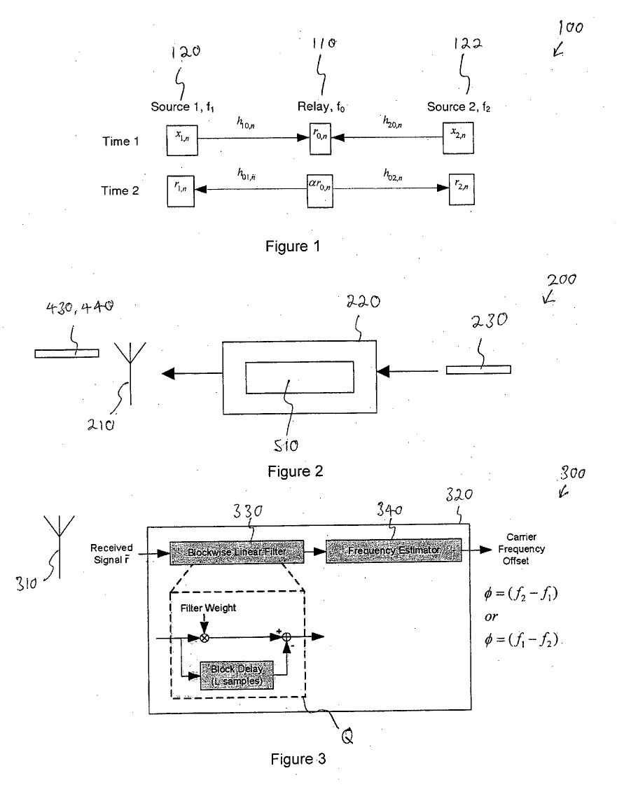

FIG. 1 shows a communications system 100 according to the preferred embodiment. The communications system 100 comprises a relay node 110 and two source nodes i.e. Source 1 120 and Source 2 122. The relay node 110 and the source nodes are each capable of two-way relay communications. In other words, Source 1 120 is capable of transmitting to the relay node 110 and receiving from the relay node 110. Similarly, Source 2 122 is also capable of transmitting to the relay node 110 and receiving from the relay node 110.

Variable S_{A} denotes a node A while h_{AB} denotes a channel from a node A to a node B. r_{A} denotes a signal received at node A. A and B may take on the values of 0, 1 and 2 in which case they respectively denote an association with the relay 110, Source 1 120 and Source 2 122. The relay node 110 and the source nodes S₁ and S₂ transmit using carrier frequencies denoted f₀, f₁ and f₂. The source nodes S₁ and S₂ may align their carrier frequencies f₁ and f₂ to that of the relay node 110 i.e. f₀. f₀ serves a common frequency and the frequency alignment at the source nodes S₁ and S₂ may be done using the technique of ranging.

In a system capable of two-way relay communications, ranging may be performed for S₁ and S₂ over two time slots. In a first time slot (i.e. Time 1) for an n-th discrete time sample, S₁ and S₂ transmit their packets respectively denoted x_{1,n} and x_{2,n} simultaneously across the channels h_{10,n} and h_{20,n} to the relay node 110. The transmitted packets x_{1,n} and x_{2,n} when received at the relay node 110 superimpose to form the received signal r_{0,n}. In a second time slot (i.e. Time 2), the relay node 110 scales the signal r_{0,n} that is earlier received during Time 1. The relay node 110 then retransmits the scaled signal back to the two sources S₁ and S₂. The retransmitted signal travels across the two independent return channels h_{01,n} and h_{02,n} to arrive respectively back at S₁ and S₂. The retransmitted signal is received as r_{1,n} and r_{2,n} at S₁ and S₂ respectively. The relay node 110 may be termed as a “responder” as it “responds” to a signal received from a source by retransmitting the signal back to the source.

The channels h_{10,n} and h_{01,n} may be different and likewise h_{20,n} and h_{02,n} may also be different. All channels may inflict frequency selective fading on transmitted signal, along with additive white Gaussian noise (AWGN). When performing ranging, small residual frequency differences of f₁−f₀ and f₂−f₀ may be present relative to the frequency f₀ at the relay node 110.

The discrete signal that S₁ receives in Time 2 for a n-th discrete time sample may be represented mathematically as

r_{1,n}=αr_{11,n}+αe^{j2π(f}^{₂}^{-f}^{₁}⁾ⁿr_{21,n}+u_{1,n} (1)

where

r_{11,n}≡h_{11,n}\textcircled{×}x_{1,n},

r_{21,n}≡h_{21,n}\textcircled{×}x_{2,n}.

r_{11,n} denotes the component signal originating from S₁ that is retransmitted back to S₁ which comprises the packets x_{1,n} originating from S₁. r_{21,n} denotes the component signal originating from S₂ which comprises the packets x_{2,n} that is transmitted onward to S₁ via the relay. It is noted that expressions similar to that of Equation 1 can also be written for the relayed signal r_{2,n} received by S₂ in Time 2.

r_{1,n} denotes the signal received at S₁ for the n-th discrete time sample. Three components are mixed together in r_{1,n}. The first component αr_{11,n} denotes the signal component originating from S₁ that is retransmitted back to S₁ from the relay node 110. It comprises the message x_{1,n} that was transmitted by S₁ to the relay node 110 in Time 1 and may be taken to have travelled across a composite channel h_{11,n} which comprises the channel from S₁ to the relay node 110 and from the relay node 110 back to S₁. α represents a scaling factor and it is noted that the first component is free of carrier frequency offset (CFO).

The second component αe^{j2π(f}^{₂}^{-f}^{₁}⁾ⁿ_{21,n} denotes the signal component originating from S₂ that is now transmitted to S₁ by way of the relay node 110. It comprises the message x_{2,n} which S₂ had sent to the relay node 110 in Time 1 and may be taken to have travelled across a composite channel h_{21,n} which comprises the channel from S₂ to the relay node 110 and from the relay node 110 to S₁. It can be seen that the second component experiences the scaling factor α and notably is afflicted with a carrier frequency offset of f₂−f₁. This CFO is the same amount as what it would have been if the relay node 110 is non-existent and a direct transmission is made from S₂ to S₁.

The third component u_{1,n} denotes coloured Gaussian noise where its correlation is time-invariant.

Source Nodes S₁ and S₂

Referring now to FIG. 2, FIG. 2 shows a transmitting portion 200 of the source nodes S₁ and S₂ of FIG. 1. The transmitting portion 200 comprises a processor 220 configured to generate a time domain signal comprising a preamble 430, 440 from a starting preamble 230, and an antenna 210 configured to transmit the preamble 430, 440 to the relay node 110. The preamble 430, 440 may be generated in the processor 220 and transmitted using the method 510 which will be described later.

The starting preamble 230 is predetermined and may be stored in a memory within the transmitting portion 200 and then be provided to the processor 220. Optionally, the starting preamble 230 may also be generated within the processor 220 using an algorithm. The starting preamble 230 may also be pre-determined to take the values of the preambles defined in the IEEE 802.11 a/g/n standards. The contents of the IEEE 802.11 a/g/n specification relating to the physical layer i.e. respectively IEEE Std 802.11a-1999, Part 11: Wireless LAN Medium Access Control (MAC) and Physical Layer (PHY) Specifications—High-speed Physical Layer in the 5 GHz Band, IEEE, 1999, IEEE Std 802.11g-2003, Part 11: Wireless LAN Medium Access Control (MAC) and Physical Layer (PHY) Specifications—Amendment 4: Further Higher Data Rate Extension in the 2.4 GHz. Band, IEEE, 2003 and IEEE Std 802.11n-2009, Part 11: Wireless LAN Medium Access Control (MAC) and Physical Layer (PHY) Specifications Amendment 5: Enhancements for Higher Throughput are incorporated herein by reference.

FIG. 3 shows a receiving portion 300 of the source nodes S₁ and S₂ of FIG. 1. The receiving portion 300 comprises an antenna 310 configured to receive a signal \tilde{r} from the relay node 110, and a processor 320 configured to estimate a carrier frequency offset φ from the received signal \tilde{r}. φ=f₂−f₁ at the source node S₁ and φ=f₁−f₂ at the source node S₂. The processor 320 further comprises a blockwise linear filter 330 and a frequency estimator 340. The blockwise linear filter 330 removes from the received signal \tilde{r} the known frequency component. This filter 330 is described to a greater detail in Step 560. A signal component comprising the carrier frequency offset φ is thus left and the carrier frequency offset φ may be estimated using the frequency estimator 340. The frequency estimator 340 may take the form of a basic correlator circuit.

It will be understood by a skilled person that while the transmitting portion 200 and the receiving portion 300 of the source nodes S₁ and S₂ are described in this specification using two separate antennae 210, 310, the antennae 210, 310 may be implemented in the source nodes S₁ and S₂ using a single antenna capable of both transmitting and receiving. Similarly, although two processors 220, 320 are described, it will be understood that a single processor may be used for both generating the rotated preambles 430, 440 as well as estimating the carrier frequency offsetφ.

Overview of CFO Estimation Using Preambles.

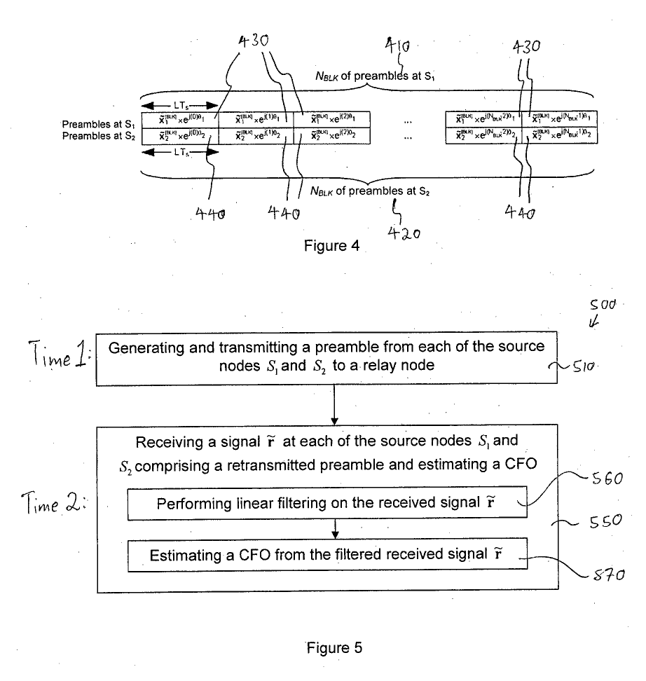

Referring now to FIGS. 4 and 5, preambles may be used to estimate the CFO f₂−f₁ present in the second component of Equation 1. FIG. 4 shows in the time domain two sets 410 and 420 of rotated preambles 430 and 440 respectively generated and transmitted from the transmitting portion of the source nodes S₁ and S₂ during Time 1. FIG. 5 shows a method 500 of estimating the CFO in the communications system 100 of FIG. 1.

The sets 410 and 420 each comprises N_{BLK} preambles respectively 430 and 440. Each preamble 430, 440 is rotated by an angle. Each preamble 430, 440 has a length of L samples with T_{S} as the sampling interval. The preambles 430, 440 of each set 410, 420 is transmitted sequentially preamble after preamble. It is noted that the angle in which each consecutive preamble is rotated varies over time and differs from each immediately preceding preamble by the angles θ₁ and θ₂ for S₁ and S₂ respectively.

The method 500 of estimating the CFO may be divided into two parts. The first part takes place in Time 1 and involves generating at each of the source nodes S₁ and S₂ rotated preambles 430 and 440 which will be transmitted to the relay node 110. The second part then takes place in Time 2 and involves receiving back at S₁ and S₂ a signal comprising the rotated preambles 430 and 440, and then performing CFO estimation on the received signal.

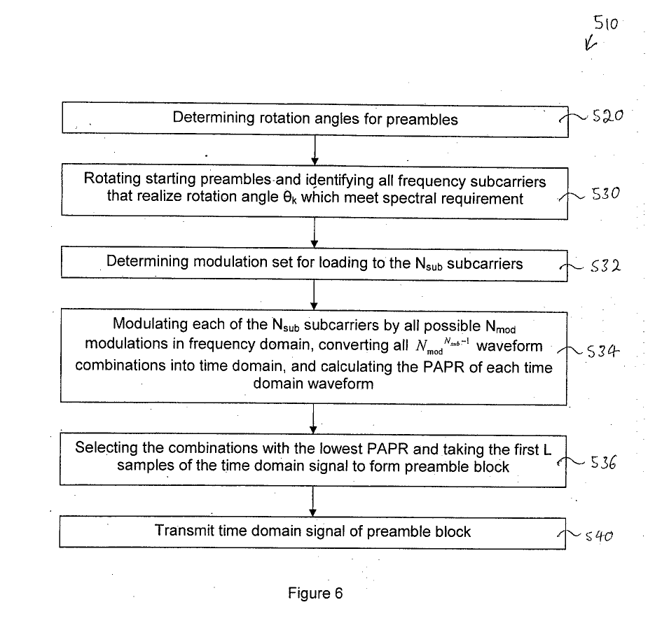

In Step 510, the rotated preambles 430 and 440 respectively are generated and transmitted from the source nodes S₁ and S₂ during Time 1. Step 510 further may comprise the Steps 520 to 540 which will be described in greater detail later with FIG. 6. It is noted that the Steps 520 to 536 optionally may be performed offline before the method 500 is carried out. The preambles 430, 440 are generated from starting preambles 230 respectively denoted x_{1,n} and x_{2,n} at the source nodes S₁ and S₂. x_{1,n} and x_{2,n} each are composed of N_{BLK} blocks of L samples and are in the time domain. Block rotations of angles kθ₁ and kθ₂ respectively are applied to each of x_{1,n} and x_{2,n} resulting in

x_{1,n+kL}=e^{jkθ}^{₁}x_{1,n}, k=0,1,2, . . . , N_{BLK}−1,

x_{2,n+kL}=e^{jkθ}^{₂}x_{2,n}, k=0,1,2, . . . , N_{BLK}−1, (2)

k is an block index while θ₁ and θ₂ are the block rotation angles respectively in use in S₁ and S₂.

As shown in FIG. 4, each set 410, 420 of rotated preambles 430, 440 respectively comprises N_{BLK} blocks of preambles with each preamble 430, 440 being L samples long. The first preamble blocks for the two sources are respectively labeled as \tilde{x}₁^{[BLK]} and \tilde{x}₂^{[BLK]}. The two sets 410 and 420 of preambles 430, 440 are respectively transmitted from the source nodes S₁ and S₂ in Time 1.

In Step 550, the CFO is estimated at the source nodes S₁ and S₂ in Time 2. The preambles 430, 440 transmitted from the source nodes S₁ and S₂ are retransmitted back to the source nodes S₁ and S₂ by the relay node 110. The retransmission is performed as a broadcast from the relay node 110 and it is received at S₁ and S₂ with the same block rotation format as when the signal was generated and transmitted from S₁ and S₂ in Time 1.

It is noted that as is shown in Equation 1, the signal received back in S₁ and S₂ are a combination of the signals transmitted from the source nodes S₁ and S₂. The signal \tilde{r} received at both the source nodes S₁ and S₂ may be represented as

r=G₁\tilde{r}₁+G₂\tilde{r}₂+ũ

ũ˜N(O,R_{Ũ}) (3)

where

$${G}_{1} ≡ [ \begin{matrix}I \\ {ρ}_{1} I \\ {ρ}_{1}^{2} I \\ ⋮ \\ {ρ}_{1}^{{N}_{CFO} - 1} I\end{matrix} ] , {G}_{2} ≡ [ \begin{matrix}I \\ {ρ}_{2} I \\ {ρ}_{2}^{2} I \\ ⋮ \\ {ρ}_{2}^{{N}_{CFO} - 1} I\end{matrix} ] , {ρ}_{1} = {e}^{j {φ}_{1}} , {ρ}_{2} = {e}^{j {φ}_{2}} , {N}_{CFO} \leq {N}_{max} , \qquad ( 4 )$$

\tilde{r}₁ and \tilde{r}₂ respectively denote the signals transmitted from the source nodes S₁ and S₂ which comprise the sets 410 and 420 of preambles 430 and 440. G₁ and G₂ respectively denote the rotation applied to \tilde{r}₁ and \tilde{r}₂. ũ denotes the Gaussian noise present in \tilde{r} and it has a zero mean and variance of R_{ũ}. Nₘₐₓ is the maximum number of blocks available for CFO estimation which is predefined depending on practical implementations and is smaller than the total number of preamble blocks N_{BLK}. N_{BLK} is a result of cyclic-prefix removal and timing misalignment between the two sources S₁ and S₂. N_{CFO} is the actual number of blocks used for CFO estimation, which may be no more than Nₘₐₓ. Further, it is noted that ρ₂ and ρ₂ denote the respective CFO of the signals \tilde{r}₁ and \tilde{r}₂as perceived back at the respective sources S₁ and S₂ in Time 2. The CFO in \tilde{r}₁ is known at S₁ and likewise the CFO in \tilde{r}₂ is known at S₂.

Thus, at the source node S₁,

\tilde{r}=r_{1,n},

\tilde{r}₁=r_{11,n},

\tilde{r}₂=r_{21,n},

ũ=u_{1,n}

φ₁=θ₁,

φ₂=2π(f₂=f₁)L+θ₂, (5)

\tilde{r}₁, \tilde{r}₂ and φ₂ are unknown while φ₁ and R_{ũ} are known. N_{CFO} is known. It is noted that \tilde{r}₁ is unknown because the channel h_{11,n} is not known to S₁, although the message x_{1,n} is known.

At the source node S₂,

\tilde{r}=r_{2,n},

\tilde{r}₁=r_{22,n},

\tilde{r}₂=u_{2,n},

ũ=u_{2,n}

φ₁=θ₂,

φ₂=2π(f₁−f₂)L+θ₁. (6)

\tilde{r}₁, \tilde{r}₂ and φ₁ are unknown while φ₂ and R_{ũ} are known. N_{CFO} is known. Similarly, \tilde{r}₂ is unknown because the channel h_{12,n} is not known. At both source nodes S₁ and S₂, φ₁ and φ₂ denote the perceived block rotation angles while θ₁ and θ₂ are the physical block rotation angles respectively for source nodes S₁ and S₂. The physical block rotation angles θ₁ and θ₂ denote the physical CFO experienced by the transmission. As the preambles 410 and 420 artificially introduce rotations θ₁ and θ₂ to the preamble blocks 430 and 440, the perceived block rotation φ₁ and φ₂ reflects the combined effect of the block rotations θ₁ and θ₂, and the physical CFO. φ₂ is the variable which comprises the CFO.

Linear filtering 560 may then be performed on the received signal \tilde{r}, and the estimation 570 of the CFO frequency from the linear filtered signal follows thereafter. These steps will be described to a greater detail later in this specification,

Preamble Generation and Transmission (Steps 520 to 540)

The generation of a preamble 430, 440 is described next by using FIG. 6. FIG. 6 shows a method 510 of generating and transmitting preambles 430, 440 at the transmitting portions 200 of the source nodes S₁ and S₂ of FIG. 1.

In 520, starting preambles 230 are provided in S₁ and S₂ and the block rotation angles θ₁ and θ₂ are determined for respective use at S₁ and S₂. The starting preambles 230 provided in S₁ and S₂ may be the same, or they may be different. The Cramer Rao bound (CRB) may be used as the criteria to determine optimal values for θ₁ and θ₂. The values of θ₁=0 and θ₂=π may be shown using the CRB to be optimal values. Thus, the rotation angles θ₁ and θ₂ may be set at the two sources to be π radians apart.

The CRB of the CFO reflects the minimum statistically achievable value for the estimation error in the CFO estimated, The CRB in estimating the CFO based on Equations 3 and 4 may be given by

$$CRB ( {φ}_{2} ) = \frac{1}{2 {\tilde{r}}_{2}^{H} {G}_{2}^{H} T [ Φ - Φ {{G}_{2} ( {G}_{2}^{H} Φ {G}_{2} )}^{- 1} {G}_{2}^{H} Φ ] {TG}_{2} {\tilde{r}}_{2}} , \qquad ( 7 )$$

where

Φ=R_{ũ}⁻¹−R_{ũ}⁻¹G₁(G₁^{H}R_{ũ}⁻¹G₁)⁻¹G₁^{H}R_{ũ}⁻¹. (8)

and T=diag(0,1,2, . . . N_{CFO}−1)★I where ★ is a Kronecker product operator. The CRB of the CFO estimate f₂−f₁ for a given r₁ may be obtained by substituting Equation 5 into Equation 7. As an example, taking the perspective of S₁, the CRB of the CFO estimate would be

$$CRB ( 2 π ( {f}_{2} - {f}_{1} ) L ) {\vert}_{{r}_{1}} = \frac{1}{2 {r}_{21}^{H} {G}_{21}^{H} T [ {Φ}_{11} - {Φ}_{11} {{G}_{21} ( {G}_{21}^{H} {Φ}_{11} {G}_{21} )}^{- 1} {fG}_{21}^{H} {Φ}_{11} ] {TG}_{21} {r}_{21}} , \qquad ( 9 )$$

where

Φ₁₁=R_{ũ1}⁻¹−R_{ũ1}⁻¹G₁₁(G₁₁^{H}R_{ũ1}⁻¹G₁₁)⁻¹G₁₁^{H}R_{ũ1}⁻¹, (10)

From Equation 5, φ₂=2π(f₂−f₁)L+θ₂. Since θ₂ is deterministic and known a priori, the CFO f₂−f₁ can be obtained from the estimate of φ₂according to f₂−f₁=(mod(φ₂−θ₂,2π)/(2πL) where mod(A,2π) is the modulo operation of A over 2π. Note that the CFO has to fall within |f₁−f₂|≦0.5/L in order for it to be estimated without any phase ambiguity. The CRB as given in Equation 7 is a joint function of the variables R_{ũ}⁻¹, \tilde{r}₂, φ₁ and φ₂. Therefore, finding the minimum of the CRB as an isolated function of φ₁ and φ₂ may involve a solution of great complexity.

By using a CRB approximation, the solution may be made tractable. In the approximation, the variables φ₁ and φ₂ are decoupled from all other variables. This approximation makes use of the knowledge that the noise covariance R_{ũ} in Equation 3 is a banded matrix. Block diagonal approximation may be made such that

R_{ũ}≈I★R_{ũUNIT} (11)

Equation 11 would offer an exact equivalence if the channel k₀₁ is flat-fading.

Consequently, the CRB of Equation 7 may be simplified to an approximate CRB of

$$\begin{matrix}ACRB ( {φ}_{2} ) = \frac{6}{( {\tilde{r}}_{2}^{H} {R}_{{\tilde{u}}_{UNIT}}^{- 1} {\tilde{r}}_{2} ) [ {N}_{CFO} ( {N}_{CFO}^{2} - 1 ) - 3 {N}_{CFO} λ ( {φ}_{2} - {φ}_{1} ) ]} \geq & ( 12 ) \\ \frac{6}{( {\tilde{r}}_{2}^{H} {R}_{{\tilde{u}}_{UNIT}}^{- 1} {\tilde{r}}_{2} ) [ {N}_{CFO} ( {N}_{CFO}^{2} - 1 ) ]} , & ( 13 )\end{matrix}$$

λ(φ₂−φ₁) is the mean squared error (MSE) of the CFO estimation error and is a non-negative function given by

$$λ ( {φ}_{2} - {φ}_{1} ) = \frac{{\vert 2 ( {g}_{1}^{H} {T}_{BLK} {g}_{2} ) - ( {N}_{CFO} - 1 ) ( {g}_{1}^{H} {g}_{2} ) \vert}^{2}}{{N}_{CFO}^{2} - {\vert {g}_{1}^{H} {g}_{2} \vert}^{2}} . \qquad ( 14 )$$

where g₁=[1, ρ₁, ρ₁², . . . , ρ₁^{N}^{_{CFO}}⁻¹]^{T}, g₂−[1, ρ₂, ρ₂², . . . , ρ₂^{N}^{_{CFO}}⁻¹]^{T}, ρ₁=e^{jφ}^{₁}, and ρ₂=e^{jφ}^{₂}. T_{BLK}=diag(0,1,2, . . . N_{CFO}−1).

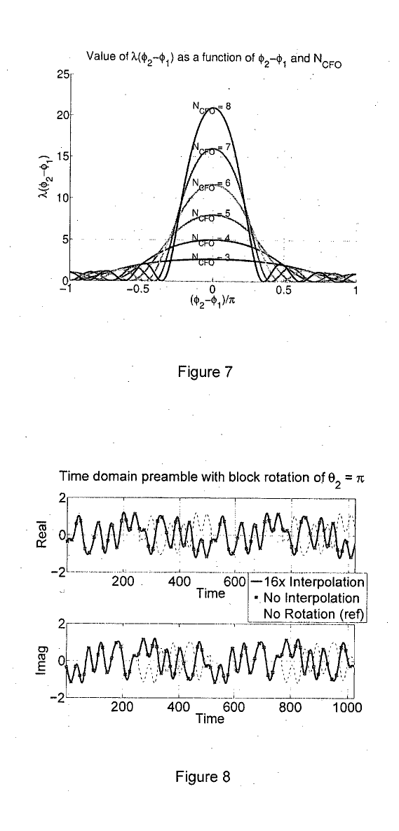

Referring now to FIG. 7, FIG. 7 shows a graph of the value of the minimum CFO estimation error i.e. λ(φ₂−φ₁) for different numbers of CFO estimation blocks N_{CFO}, as the CFO φ₂−φ₁ is varied. The function λ(φ₂−φ₁) tends to be small when the difference is −π or π for any N_{CFO}. This may suggest that a robust choice is to design the preamble such that this difference is close to −π or π.

It may be seen in Equation 12 that by applying Equation 11 to Equation 7, the block rotation angles φ₁ and φ₂ are now detached from R_{ũ}⁻¹ and \tilde{r}₂. This allows the approximate CRB to be minimized independently of R_{ũ}⁻¹ and \tilde{r}₂ and a specific value of φ₂−φ₁ that minimizes the non-negative function λ(φ₂−φ₁) may be obtained.

As shown in FIG. 7, when φ₂−φ₁=0, π(φ₂−φ₁) is at its maximum for any N_{CFO} and the effective CRB in Equation 12 becomes

$$\begin{matrix}{lim}_{{φ}_{2} - {φ}_{1} \to 0} ACRB ( {φ}_{2} ) = \frac{6}{( {\tilde{r}}_{2}^{H} {R}_{{\tilde{u}}_{UNIT}}^{- 1} {\tilde{r}}_{2} ) [ \begin{matrix}{N}_{CFO} ( {N}_{CFO}^{2} - 1 ) - \\ 3 {N}_{CFO} ( {lim}_{{φ}_{2} - {φ}_{1} \to 0} λ ( {ϕ}_{2} - {ϕ}_{1} ) )\end{matrix} ]} \\ = ∞\end{matrix} \qquad ( 15 )$$

λ(φ₂−φ₁) is at its maximum because the preambles 430 and 440 communicated respectively from the two sources S₁ and S₂ in Time 1 cannot be differentiated when they arrive back at the sources in Time 2.

The difference between the perceived rotation angles for S₁ and S₂ i.e. φ₂ −φ₁ is composed, according to Equation 5 and 6, of

$${φ}_{2} - {φ}_{1} = \{ \begin{matrix}2 π ( {f}_{2} - {f}_{1} ) L + ( {θ}_{2} - {θ}_{1} ) , & at {S}_{1} \\ 2 π ( {f}_{1} - {f}_{2} ) L + ( {θ}_{1} - {θ}_{2} ) , & at {S}_{2}\end{matrix} \qquad ( 16 )$$

Since the physical CFO i.e. ±(f₁−f₂) may be small as a result of ranging, a small value of φ₁−φ₂ is caused by a small value of θ₁−θ₂. Consequently, to avoid obtaining φ₂−φ₁=0, the block rotation angles θ₁ and θ₂ should not be θ₂=θ₁. In other words, S₁ and S₂ should not both send periodic preambles. The sending of periodic preambles at both source nodes S₁ and S₂ is a worst case fallback situation. Equation 15 would hold for Equation 7 where no approximation is involved. This is because where φ₂−φ₁=0, the matrix G₂^{H}ΦG₂ becomes singular and the CRB(φ₂) of Equation 7 becomes infinite.

It may also be seen that the lower bound given in Equation 13 corresponds to the case when S₁ sends nothing in Time 1. This suggests a reduction to a one-way relay scenario where the two sources S₁ and S₂ take turns to transmit messages, with each turn lasting 2 slots i.e. in Time 1 and Time 2. In a one-way relay scenario, the relay node 110 relays in Time 2 the message it receives in Time 1.

Further, if the channel is flat-fading then the lower bound will be the CRB for the effective CFO φ₂ in point-to-point transmission. This means that S₁ and S₂ may be able to perform interference-free communication. The lower bound is attainable when φ₂−φ₁=π and N_{CFO} is odd, since

$$λ ( {φ}_{2} - {φ}_{1} ) {\vert}_{{φ}_{2} - {φ}_{1} = π} = \{ \begin{matrix}0 , & {N}_{CFO} is odd , \\ 1 , & {N}_{CFO} is even .\end{matrix} \qquad ( 17 )$$

Using Equation 16, it is determined that φ₂−φ₁=π when θ₂−θ₁=π. The physical CFO f₂−f₁ may be negligible as a result of ranging. Accordingly, to minimize modification to the conventional preamble, the physical block rotation angles for S₁ and S₂ may be

θ₁=0 and θ₂=π (18)

In this case, θ₁ and θ₂ are assigned such that they are equally spaced over the range between 0 and π i.e. they are spaced π radians apart and may achieve the estimation performance of the CRB lower bound. It is noted that no constraint is imposed on the number of relay nodes or the number of antennas in each relay node.

It is noted that while the CRB and approximate CRB of the CFO are described above using S₁ as an example, it is understood that the CRB and approximate CRB of the CFO may be similarly obtained for S₂.

Returning now to FIG. 6, in Step 530, the starting preambles 230 of source nodes S₁ and S₂ are respectively rotated by the block rotation angles θ₁ and θ₂ in the time domain and subjected to spectral regulations to form rotated preamble 430 and 440. The spectral regulations applied comprise restricting the power of the subcarriers of the frequency domain signals to stay below a spectral mask. It is noted that the rotation of the block of time domain signals may be seen as applying a frequency shift to the corresponding frequency domain signals.

Using a specific example, the starting preambles 230 which are provided are of the IEEE 802.11a/g/n design at both source nodes S₁ and S₂. The periodic training sequence for CFO estimation, which are known as short preambles, are used as the starting preambles 230 and they are constructed as 10 blocks of 16 samples each. In other words, N_{BLK}=10 and L=16. The communications system 100 uses orthogonal frequency-division multiplexing (OFDM) with each symbol comprising 64 samples.

The block rotation angles θ₁ and θ₂ are taken as in Equation 18. In this case, the starting preamble 230 may be said to be scaled by a factor of unit amplitude and the preamble 430 after block rotation is similar to the starting preamble 230. At source node S₂, the block rotation angle θ₂=π is used and the starting preamble 230 is rotated by θ₂=π.

As an example, the PAPR is next minimized such that the preambles satisfy the IEEE802.11a/g spectral mask. It is noted that there may be a large number of candidate signals that may satisfy the spectral mask and the signal with the lowest PAPR is as given in Equations 19 and 20. The optimized preambles at S₁ and S₂ are given respectively by

$$\begin{matrix}{\tilde{X}}_{1 , k} = \{ \begin{matrix}+ \sqrt{\frac{52}{12}} ( \frac{1 + j}{\sqrt{2}} ) , & k ∈ \{ \begin{matrix}12 , 16 , 20 , 24 , \\ 40 , 48 , 60\end{matrix} \} , & \\ - \sqrt{\frac{52}{12}} ( \frac{1 + j}{\sqrt{2}} ) , & k ∈ \{ 4 , 8 , 44 , 52 , 56 \} , & \begin{matrix}k = \\ 0 , 1 , 2 , … , 63\end{matrix} \\ 0 , & otherwise . & \end{matrix} & ( 19 ) \\ and & \\ {\tilde{X}}_{2 , k} = \{ \begin{matrix}+ \sqrt{\frac{52}{14}} ( \frac{1 + j}{\sqrt{2}} ) , & k ∈ \{ \begin{matrix}18 , 26 , 38 , 42 , \\ 54 , 58\end{matrix} \} , & \\ - \sqrt{\frac{52}{14}} ( \frac{1 + j}{\sqrt{2}} ) , & k ∈ \{ \begin{matrix}2 , 6 , 10 , 14 , 22 , \\ 46 , 50 , 62\end{matrix} \} , & \begin{matrix}k = \\ 0 , 1 , 2 , … , 63\end{matrix} \\ 0 , & otherwise . & \end{matrix} & ( 20 )\end{matrix}$$

where \sqrt{52/12} is a normalization factor to ensure that both \tilde{X}_{1,k} and \tilde{X}_{2,k} consume the same average power.

Specifically, in the present example, the preambles may be optimized as follows. The IEEE802.11a/g spectral mask blocks the frequency bins {0, 27, 28, 29, . . . , 35, 36, 37} out of a total of 64 frequency bins that correspond to the 64 discrete Fourier transform (DFT). It is noted that the spectral mask for IEEE 802.11a/g are stricter than that for IEEE 802.11 n.

In the case of S₂, as will be shown later in Equation 26, after converting \tilde{X}_{2,k} into time domain with a discrete Fourier transform (DFT), only the 16 frequency locations {2, 6, 10, 14, 18, 22, 26, 30, 34, 38, 42, 46, 50, 54, 58, 62} are occupied as a result of the selected block rotation. There is an overlap with the spectral mask at locations {30, 34} and these overlapped locations are eliminated. A subset covering 14 of the 16 frequency bins at {2, 6, 10, 14, 18, 22, 26, 38, 42, 46, 50, 54, 58, 62} can therefore be retained.

In Step 532, at each of the source nodes S₁ and S₂, the modulation set for each of the subcarriers is determined. This involves determining the constellations available for modulation. In the present example, as is the same as that used by the short training sequence in IEEE 802.11a/g/n, two constellations are available in the form of ±(1+j)/\sqrt{2}. Consequently, the size of the modulation set is N_{mod}=2.

In Step 534, at each of the source nodes S₁ and S₂, each of the N_{sub} subcarriers is modulated by every one of the N_{mod} possible constellations in the frequency domain. The loaded frequency domain signals in S₁ is reflected in Equation 19 and as 12 subcarriers are loaded, N_{sub}=12. There will thus be N_{mod}^{N}^{_{sub}}⁻¹=2¹²⁻¹ possible combinations in S₁.

In S₂, the loaded frequency domain signals is reflected in Equation 20 and as 14 subcarriers are loaded, N_{sub}=14. The available degrees of freedom for permutation thus results in a total of 2¹⁴⁻¹ possible combinations (instead of 2¹⁴ because two sets of 64-sample designs are essentially identical if one can be generated from the other by a flip of signs in every sample).

When modulating each of the each of the N_{sub} subcarriers in S₁ and S₂, the loaded frequency domain signals (i.e. \tilde{X}_{1,k} or \tilde{X}_{2,k} for k=0,1,2, . . . , 63) which have not been eliminated are converted into the time domain. This may be done by performing a 64-point DFT on \tilde{X}_{1,k} or \tilde{X}_{2,k}. Up-sampling and interpolation is also employed in converting the frequency domain signal to the time domain so as to capture the time domain signal values occurring between samples. For every modulation done, the peak-to-average power ratio (PAPR) is calculated.

In Step 536, at each of the source nodes S₁ and S₂, the one out of N_{mod}^{N}^{_{sub}}⁻¹ combination with the lowest PAPR is chosen to be an optimal modulation. By doing so, the PAPR of the transmission is minimized and the combination chosen thus yields an optimized modulation. At the source node S₁, the time domain signal with the optimized modulation is obtained as \tilde{x}_{1,n}, n=0,1,2, . . . , 63. Blocks of L samples each are formed. In the present example, the time domain signal has a period of L=16 samples and \tilde{x}_{1,1} may be grouped to form blocks of L=16 samples using the assignment

$${\tilde{x}}_{1 , n} = {( {e}^{jπ} )}^{\frac{n - m}{16}} {\tilde{x}}_{1 , m} , n = 0 , 1 , 2 , … , 63 , m = mod ( n , 16 ) , \qquad ( 21 )$$

This thus results in

$$\begin{matrix}DFT ( [ \begin{matrix}{\tilde{x}}_{1 , 0} \\ {\tilde{x}}_{1 , 1} \\ {\tilde{x}}_{1 , 2} \\ ⋮ \\ {\tilde{x}}_{1 , 63 - 1}\end{matrix} ] ) = DFT ( [ \begin{matrix}{( - 1 )}^{0} {\tilde{x}}_{1}^{[ BLK ]} \\ {( - 1 )}^{1} {\tilde{x}}_{1}^{[ BLK ]} \\ {( - 1 )}^{2} {\tilde{x}}_{1}^{[ BLK ]} \\ {( - 1 )}^{3} {\tilde{x}}_{1}^{[ BLK ]}\end{matrix} ] ) , & ( 22 ) \\ where & \\ {\tilde{x}}_{1}^{[ BLK ]} = [ \begin{matrix}{\tilde{x}}_{1 , 0} \\ {\tilde{x}}_{1 , 1} \\ {\tilde{x}}_{1 , 2} \\ ⋮ \\ {\tilde{x}}_{1 , L - 1}\end{matrix} ] , L = 16 , & ( 23 )\end{matrix}$$

The set 410 of preambles 430 at S₁ may then be expressed as

$${\tilde{x}}_{1} = \sqrt{\frac{64}{52} {P}_{1}} [ \begin{matrix}{\tilde{x}}_{1}^{[ BLK ]} \\ {\tilde{x}}_{1}^{[ BLK ]} \\ {\tilde{x}}_{1}^{[ BLK ]} \\ ⋮ \\ {\tilde{x}}_{1}^{[ BLK ]}\end{matrix} ] \} {N}_{BLK} times \qquad ( 24 )$$

N_{BLK} here is 4 and P₁ is a variable denoting the power at which the preamble 430 at S₁ would be transmitted. Each of the N_{BLK} preamble 430 blocks after the first is then generated by rotating the immediately preceding block by the angle θₖ=π/2^{k}, for k=1,2, . . . ,

$${log}_{2} ( \frac{N}{2 L} ) ,$$

where N is the DFT size and L the length of each block. This is equivalent to multiplying each immediately preceding block by e^{jθ}^{ₖ}. Thus, taking Equation 24 as an example, since N=64, L=16, then

$${θ}_{k} ∈ \{ 0 , π , \frac{π}{2} , \frac{π}{4} \} .$$

Similarly, at the source node S₂, the optimized time domain signal \tilde{x}_{2,n}, n=0,1,2, . . . , 63 is obtained from a 64-point DFT of \tilde{X}_{2,k} after modulation. Once again, the assignment used to group the samples into blocks of size L=16 is

$${\tilde{x}}_{2 , n} = {( {e}^{jπ} )}^{\frac{n - m}{16}} {\tilde{x}}_{2 , m} , n = 0 , 1 , 2 , … , 63 , m = mod ( n , 16 ) \qquad ( 25 )$$

This results in

$$\begin{matrix}DFT ( [ \begin{matrix}{\tilde{x}}_{2 , 0} \\ {\tilde{x}}_{2 , 1} \\ {\tilde{x}}_{2 , 2} \\ ⋮ \\ {\tilde{x}}_{2 , 63 - 1}\end{matrix} ] ) = DFT ( [ \begin{matrix}{( - 1 )}^{0} {\tilde{x}}_{2}^{[ BLK ]} \\ {( - 1 )}^{1} {\tilde{x}}_{2}^{[ BLK ]} \\ {( - 1 )}^{2} {\tilde{x}}_{2}^{[ BLK ]} \\ {( - 1 )}^{3} {\tilde{x}}_{2}^{[ BLK ]}\end{matrix} ] ) , & ( 26 ) \\ where & \\ {\tilde{x}}_{2}^{[ BLK ]} = [ \begin{matrix}{\tilde{x}}_{2 , 0} \\ {\tilde{x}}_{2 , 1} \\ {\tilde{x}}_{2 , 2} \\ ⋮ \\ {\tilde{x}}_{2 , L - 1}\end{matrix} ] , L = 16 , & ( 27 )\end{matrix}$$

The set 420 of preambles 440 at S₂ may then be expressed as

$${\tilde{x}}_{2} = \sqrt{\frac{64}{52} {P}_{2}} [ \begin{matrix}{( - 1 )}^{0} {\tilde{x}}_{2}^{[ BLK ]} \\ {( - 1 )}^{1} {\tilde{x}}_{2}^{[ BLK ]} \\ {( - 1 )}^{2} {\tilde{x}}_{2}^{[ BLK ]} \\ ⋮ \\ {( - 1 )}^{{N}_{BLK} - 1} {\tilde{x}}_{2}^{[ BLK ]}\end{matrix} ] , \qquad ( 28 )$$

P₂ is a variable denoting the power at which the preamble 430 at S₂ would be transmitted. Each of the N_{BLK} preamble 440 blocks after the first is then generated by rotating the immediately preceding block by the angle θ₄=π/2^{k}, for k=1,2, . . . ,

$${log}_{2} ( \frac{N}{2 L} ) ,$$

where N is the DFT size and L the length of each block. This is equivalent to multiplying each immediately preceding block by. e^{jθ}^{ₖ}.

As a point of note, if the first block of \tilde{x}₁ from Equation 24 is taken to be \tilde{x}₂^{[BLK]}=\tilde{x}₁^{[BLK]}, the spectral mask is violated. Thus, a separate design for \tilde{x}₂^{[BLK]} that differs from \tilde{x}₁^{[BLK]} is used.

It is noted that while the Steps 520 to 536 have been described such that S₁ and S₂ perform their processing concurrently, S₁ and S₂ may optionally perform the Steps 520 to 536 not in a concurrent manner. Further, S₁ and S₂ may operate one after another.

In the present example, the loaded frequency domain signals with a design according to Equation 19 in S₁ have a PAPR of 2.24 dB. It is noted that the design of Equation 19 is similar to that for a conventional in IEEE 802.11a/g/n preamble. The loaded frequency domain signals with the design of Equation 20 in S₂ have a PAPR of 2.20 dB. Thus, the preamble designs of Equation 20 may have the advantage of a lower PAPR. This may also demonstrate that there are sufficient degrees of freedom present to support a PAPR optimization.

Further, while Steps 534 and 536 have been described using a lowest PAPR as an optimization criterion, it is envisaged that some other criterion of optimization for utilizing the available degrees of freedom may be adopted, for example, the minimization of the auto- and/or cross-correlation of the time domain signals.

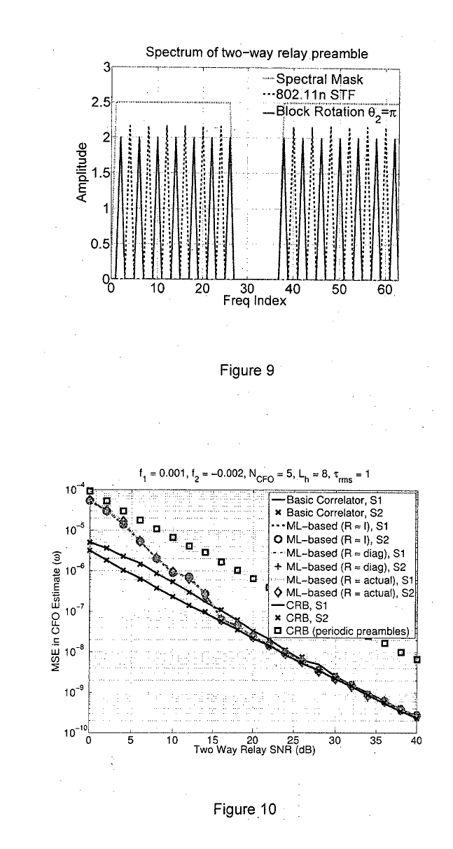

Referring to FIGS. 8 and 9, FIG. 8 shows the time domain waveform of \tilde{x}_{2,n} while FIG. 9 shows the frequency domain waveform of \tilde{X}_{2,k}. Both waveforms are that of the source node S₂ where the block rotation angle is θ₂=π. In FIG. 8, the time domain waveform of \tilde{x}_{2,n} is contrasted against a corresponding time domain waveform generated under similar conditions but within block rotation. In FIG. 9, it may be seen that the waveform of \tilde{X}_{2,k} achieves full compliance with the spectral mask requirement since it falls within the spectral mask.

Returning back to FIG. 6, in Step 540, the set 410 of preambles 430 at S₁ is transmitted by S₁. Also, the set 420 of preambles 440 at S₂ is transmitted by S₂. The transmission from S₁ and S₂ is perform simultaneously.

Linear Filtering (Step 560)

The transmission of the time domain signals from S₁ and S₂ respectively comprising the sets 410 and 420 of preambles 430 and 440 takes place in Time 1. In Time 2, the signal \tilde{r} is received at both S₁ and S₂ from the relay node 110.

In Step 560, linear filtering is performed on the received signal \tilde{r}. A difference between two-way relay communication systems and point-to-point transmission systems is that in the former system, two frequency tones are processed, as opposed to one frequency tone in the latter system. As may be seen from Equation 3, the received signal \tilde{r} comprises two frequency tones respectively present in \tilde{r}₁ and \tilde{r}₂.

At each of the source nodes S₁ and S₂, one of the frequencies is known a priori and this known frequency may be removed using a customized filter. Such a filter thus may perform self-interference mitigation before CFO estimation is performed in Step 570. Using the source node S₁ as an example, a simple blockwise filter Q as defined in Equation 29 may be used to remove the known frequency component φ₁ from the received signal F as defined by Equations 3, 4 and 5.

$${Q}^{H} = [ \begin{matrix}{ρ}_{1} I & - I & & & & O \\ & {ρ}_{1} I & - I & & & \\ & & {ρ}_{1} I & - I & & \\ & & & ⋱ & ⋱ & \\ O & & & & {ρ}_{1} I & - I\end{matrix} ] ∈ {ℂ}^{( {N}_{CFO} - 1 ) L \times {N}_{CFO} L} , \qquad ( 29 )$$

Since

Q^{H}G₁=O, (30)

the filter output may be given as \tilde{z}.

$$\tilde{z} = [ \begin{matrix}{z}_{0} \\ {z}_{1} \\ {z}_{2} \\ ⋮ \\ {z}_{{N}_{CFO} - 2}\end{matrix} ] ≡ {Q}^{H} \tilde{r} = {Q}^{H} {G}_{2} {\tilde{r}}_{2} + {Q}^{H} \tilde{u} = ( {ρ}_{1} - {ρ}_{2} ) [ \begin{matrix}I \\ {ρ}_{2} I \\ {ρ}_{2}^{2} I \\ ⋮ \\ {ρ}_{2}^{{N}_{CFO} - 2} I\end{matrix} ] {\tilde{r}}_{2} + {Q}^{H} \tilde{u} . \qquad ( 31 )$$

It is noted that filtering may have the potential of reshaping and further colouring the perceived noise spectrum. This may result in a loss in the CFO estimation performance. The method 500 of estimating the CFO however may not suffer from such a loss in estimation performance as will be shown later by checking if the Cramer-Rao bound (CRB) for the component comprising the CFO estimate (i.e. the component comprising φ₂) from the filtered signal is any larger than that from the signal before filtering. The CRB of φ₂ may be calculated using Equation 7 as

$$\tilde{CRB} ( {φ}_{2} ) = \frac{1}{2 {\tilde{r}}_{2}^{H} {G}_{2}^{H} T [ \tilde{Φ} - \tilde{Φ} {{G}_{2} ( {G}_{2}^{H} \tilde{Φ} {G}_{2} )}^{- 1} {G}_{2}^{H} \tilde{Φ} ] {TG}_{2} {\tilde{r}}_{2}} \qquad ( 32 )$$

where

\tilde{Φ}=Q(Q^{H}R_{ũ}Q)⁻¹Q^{H}. (33)

It can be shown that using Equation 8 and 30 that \tilde{Φ}=Φ. Thus using Equation 7, \tilde{C}\tilde{R}\tilde{B}(φ₂)=CRB(φ₂). Since the CRB of φ₂ i.e. \tilde{C}\tilde{R}\tilde{B}(φ₂) is not larger than that from the signal before filtering i.e. CRB(φ₂), it may be said that the blockwise linear filter Q removes the known frequency i.e. φ₁ without comprising the CRB and thus without causing a loss in the CFO estimation.

Estimating the CFO Frequency (Step 570)

In Step 570, the frequency of the CFO is estimated from the linear filtered signal. After applying filtering on the received signal, only one frequency tone may be left in the filtered signal and estimating the CFO may thus be performed using any of the techniques known to the skilled person for CFO estimation in point-to-point transmission, e.g. using a Maximum Likelihood (ML) based estimator

The problem of CFO estimation may now be described as estimating a single tone in the presence of coloured noise. It is noted that the filter Q may have the advantage of being self-interference-free. Thus, the basic correlator may be used.

$${φ}_{2 , EST} = ∠ {\sum }_{m = 0}^{{N}_{CFO} - 3} {z}_{1 , m}^{H} {z}_{1 , m + 1} \qquad ( 34 )$$

φ_{2,EST} denotes the CFO estimate and \tilde{z} refers to the filter output of Equation 31. The use of the basic correlator may have the advantage of being exceptionally simple.

Simulation. Results

Simulations are conducted using the preambles 430 and 440 obtained from the method 510 of generating and transmitting the preambles. These simulations use the linear filtering 560 to remove the known frequency. In the simulations, all channel taps experience independent Rayleigh fading, with their magnitude regulated by the exponential power delay profile e^{-n/τ}^{ᵣₘₛ}, where n is the tap index and τᵣₘₛ is the root-mean-squared delay spread. Three sets of channel parameters that describe an escalating degree of delay spread are used in the simulation
Scenario 1: Lₕ=8 where τᵣₘₛ=1;
Scenario 2: Lₕ=16 where τᵣₘₛ=5; and
Scenario 3: Lₕ=16 where τᵣₘₛ=∞.

The channel parameters of Scenario 3 correspond to the uniform power delay profile model and acts as the worst delay spread scenario for comparison.

For simplicity, it is assumed that the two source nodes S₁ and S₂ communicate in equal power i.e. P=P₁=P₂ and that the variance of the AWGN at all the receivers are identical σᵥ²=σᵥ_{₀}²=σᵥ_{₁}²=σᵥ_{₂}², i.e. σᵥ²=R_{Ũ}. The signal-to-noise ratio is defined as SNR=P/σᵥ². The scaling factor α is applied at the relay is set to keep the total transmit power P₀ at the relay in Time 2 equal to that in Time 1, i.e. P₀=P₁+P₂=2P . The latter allows conformity to the maximum transmit power requirement that limits the interference caused to other co-channel users.

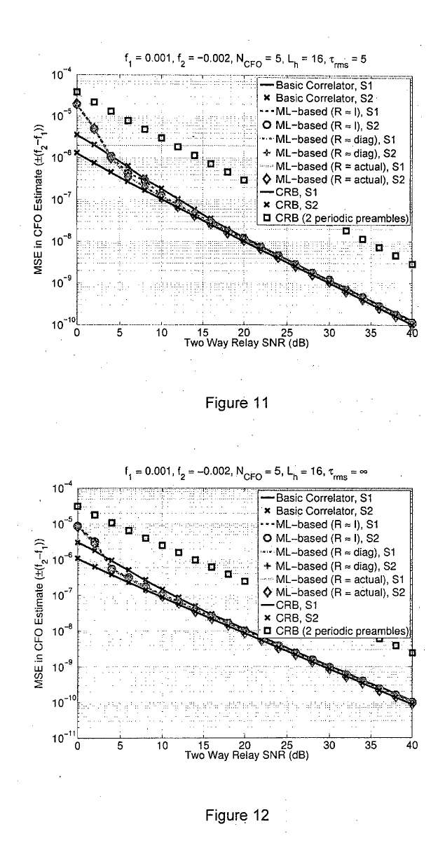

FIG. 10 is a graph showing the MSE in CFO estimation as the SNR is varied and where f₁=0.001, f₂=−0.002 and N_{CFO}=5, and where Scenario 1 is applied. FIG. 11 is a graph showing the MSE in CFO estimation as the SNR is varied and where f₁=0.001, f₂=−0.002 and N_{CFO}=5, and where Scenario 2 is applied. FIG. 12 is a graph showing the MSE in CFO estimation as the SNR is varied and where f₁=0.001, f₂=−0.002and N_{CFO}=5, and where Scenario 3 is applied. In these three graphs, the estimators used are either basic correlators (i.e. such as that of Equation 34) and Maximum Likelihood (ML) based estimators. In all cases the method 500 of estimating the CFO is used. Curves showing the Cramer Rao bound performance from the perspective of S₁ and S₂ are also presented, as is a curve showing the Cramer Rao bound performance when periodic preambles are used.

As may be seen from the curves, the CRB performance using periodic preambles perform the worst in all three graphs and by replacing the periodic preambles with the preambles 430, 440, the MSE is reduced by more than 28 times. The approximate CRB as derived in Equation 12 were also evaluated but are not displayed in the FIGS. 10, 11 and 12. The performance with approximate CRB differ from that with exact CRB computed with Equation 7 by less than 1% for the least dispersive channel (i.e. the channel with conditions of Scenario 1), and slightly more than 1% for the most dispersive channel (i.e. the channel with conditions of Scenario 3). Thus, it may be said that using the approximate CRB in the design of the preambles 430, 440 is appropriate. Further, the MSE performance at S₁ and S₂ may be observed to be almost identical. This may be because they transmit at equal power, and also because all channels are statistically equivalent, which accordingly keeps the system symmetric.

Comparing between the estimators used, FIGS. 10, 11 and 12 shows that the basic correlator is able to produce a lower MSE that is about 1.25 times higher than that of the CRB at high SNR values. Further, it may be seen that the smaller the τᵣₘₛ value, the closer is the MSE of the basic correlator to the CRB performance. Specifically, in relation to FIG. 12 where τᵣₘₛ=∞, the MSE of the basic correlator is 1.25 times higher than that of the CRB performance. In FIG. 10 however where τᵣₘₛ=1, the MSE of the basic correlator is 1.1 times higher than that of the CRB performance. It is notable that the basic correlator may produce performance close to that of the CRB despite its simple structure and it having no channel information.

Further, the basic correlator is shown in FIGS. 10, 11 and 12 to outperform the ML based schemes by yielding lower MSE in all three scenarios at low SNR levels. The narrow performance gap between the curves at the high SNR levels for FIGS. 10, 11 and 12 suggests that the preambles generated and transmitted using the method 510 may be robust against the choice of estimators used in determining the CFO estimate.

In this specification, the terms “preamble” and “preamble blocks” have been used interchangeably to refer to a preamble 430 and/or 440. The terms “source” and “source node” have been used interchangeably to refer to a source node 120,122 of the communication system 100.

While the method 500 has been described above with reference to a two-way relaying scenario (where there are only two source nodes), it is envisaged that the method 500 however may be applied to a multi-way relaying scenario involving K (more than one) sources. In this case, each source is furnished with a pre-determined set of starting preambles 230. The block rotation angles to be applied to the K sets, θ₁, θ₂, . . . , θ_{K} of starting preambles 230 are assigned such that they are equally spaced over the range between 0 and π.

Whilst example embodiments of the invention have been described in detail, many variations are possible within the scope of the invention as will be clear to a skilled reader.

Further, it will be understood by a skilled person that the source and/or relay nodes may be implemented as mobile devices such as mobile phones and/or as stationary devices such as base stations. Also, it is envisaged that the source and/or relay nodes may be implemented as integrated circuits or a system-on-chip solutions.

1. A method for estimating carrier frequency offset at a communications device, the method comprising
generating a block of signals;
rotating the block by a plurality of different rotation angles to form a corresponding first set of preambles;
transmitting the first set of preambles as a time domain signal to a relay;
receiving a retransmitted time domain signal from the relay, the retransmitted time domain signal being a combination of the first set of preambles and a second set of preambles from another communication device; and
estimating the carrier frequency offset based on the received retransmitted time domain signal.

2. A method for estimating carrier frequency offset according to claim 1 further comprising
applying an optimized modulation to the first set of preambles to form the time domain signal.

3. A method for estimating carrier frequency offset according to claim 2 wherein each signal of the block of signals correspond to respective ones of a plurality of subcarriers used for transmitting the first set of preambles.

4. A method for estimating carrier frequency offset according to claim 3 wherein applying the optimized modulation comprises
permuting a plurality of combinations each associating an arrangement of the rotated block of signals with a plurality of constellations;
modulating each of the plurality of combinations with respective ones of the plurality of subcarriers; and
selecting from the modulated plurality of combinations a selected signal of an optimal combination, the optimal combination minimizing the peak-to-average power ratio of the corresponding signal; wherein the selected signal is the time domain signal.

5. A method for estimating carrier frequency offset according to claim 1, wherein rotating the block comprises
determining a plurality of modulation symbols used by the plurality of subcarriers to form each of the first set of preambles.

6. A method for estimating a carrier frequency offset according to claim 5 wherein rotating at the communications device the generated block of signals further comprises
shifting a frequency of each of the signals by applying one of the plurality of different rotation angles.

7. A method for estimating a carrier frequency offset according to claim 6 wherein rotating at the communications device the generated block of comprises scaling an amplitude of each of the signals.

8. A method for estimating carrier frequency offset according to claim 1 wherein one of the plurality of different rotation angles is obtained from the number of the plurality of subcarriers and a predetermined length of the time domain signal.

9. A method for estimating carrier frequency offset according to claim 1 wherein one of the plurality of different rotation angles is obtained from an angle of a previous block of signals.

10. A method for estimating a carrier frequency offset according to claim 1 wherein one of the plurality of different rotation angles is determined using a Cramer Rao bound of the carrier frequency offset estimate.

11. A method for estimating carrier frequency offset according to claim 10 wherein the Cramer Rao bound is an approximation.

12. A method for estimating carrier frequency offset according to claim 10 wherein one of the plurality of different rotation angles has a value between and inclusive of 0 and π.

13. A method for estimating a carrier frequency offset according to claim 1 wherein one of the plurality of different rotation angles is obtained according to the number of other communication devices.

14. A method for estimating a carrier frequency offset according to claim 1 wherein the generated block is an IEEE 802.11 preamble.

15. A method for estimating carrier frequency offset according to claim 1 wherein one of the first set of preambles is obtained from rotating a preceding rotated block of signals.

16. A method for estimating carrier frequency offset according to claim 1 wherein the time domain signal is transmitted using orthogonal frequency-division multiplexing.

17. A method for estimating carrier frequency offset according to claim 1 wherein the time domain signal is non-periodic.

18. A method for estimating a carrier frequency offset according to claim 1 wherein the retransmitted time domain signal comprises a training signal retransmitted by the relay from another device.

19. A method for estimating carrier frequency offset according to claim 1 wherein the carrier frequency offset is between the time domain signal and the received retransmitted time domain signal.

20. A method for estimating carrier frequency offset according to claim 1 wherein estimating the carrier frequency offset comprises linear filtering the received retransmitted time domain signal.

21. A method for estimating carrier frequency offset according to claim 20 wherein estimating the carrier frequency offset further comprises performing correlation on the linear filtered signal.

22. A relaying method for estimating carrier frequency offset at a first communications device, the method comprising
receiving at a relay a first time domain signal which is transmitted from the first communications device, and a second time domain signals which is transmitted from a second communications device;
wherein the first time domain signal comprises a first set of preambles formed by rotating a first generated block of signals by a corresponding first plurality of different rotation angles; and
wherein the second time domain signal comprises a second set of preambles formed by rotating a second generated block of signals by a corresponding second plurality of different rotation angles; and
retransmitting from the relay a retransmitted time domain signal to the first communications device so as to allow the first communications device to estimate the carrier frequency offset based on the retransmitted time domain signal, which is a combination of the first and second sets of preambles.

23. A method for estimating a carrier frequency offset in a communication system, the communications system comprising a first communications device, a second communications device and a relay, the method comprising
rotating at the first communications device a first generated block of signals by a first plurality of different rotation angles to form corresponding first set of preambles;
rotating at the second communications device a second generated block of signals by a second plurality of different rotation angles to form corresponding second set of preambles;
transmitting from each of the first and second communications devices the respective first and second sets of preambles as time domain signals to the relay;
receiving at the first communications device a retransmitted time domain signal from the relay, the retransmitted signal being a combination of the first and second sets of preambles; and
estimating the channel frequency offset based on the received retransmitted time domain signal.

24. A method for estimating carrier frequency offset according to claim 23 wherein a starting angle of the first plurality of different rotation angles and a starting angle of the second plurality of different rotation angles differ by π.

25. A method for estimating a carrier frequency offset according to claim 24 wherein the starting angle of the first plurality of different rotation angles is 0.

26-47. (canceled)
